(19) United States
(12) Patent Application Publication
(10) Pub. No.: US 2008/0183694 A1
(43) Pub. Date: Jul. 31, 2008

(54) Method and system presenting search results using relationship information

(76) Inventors: Daniel Cane, Arlington, VA (US); Michael Chasen, Bethesda, MD (US); Scott Perian, Boulder, CO (US); Timothy R. Chi, Chevy Chase, MD (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/701,238

(22) Filed: Jan. 31, 2007

(51) Int. Cl. G06F 17/30

(52) U.S. Cl. 707/5

(57) ABSTRACT

A web site for publishing content for a plurality of users allows searching of the contact to be affected by the social network of the searcher. A user has a social network that is measured by the degrees of separation between the user and other users and groups. In other words, “friends of friends” are further separated than “friends”. This information is useful when search results are returned that include content published by other users. The degree of separation between the searcher and the other user is used to rank the search results.

### BACKGROUND

1. Field

The present disclosure relates generally to networked computer systems, and more particularly, to systems and methods for providing online communities.

2. Background

With the vast amounts of information that is available from the Internet, search engines and search techniques continue to be areas of ardent research and development. Many users find the. Internet overwhelming and unusable without the assistance of search engines that allow keyword and other types of searching to winnow information into a useful amount. As is well known, users typically visit a search engine portal that allows keyword searching along with varying degrees of Boolean connectors to help optimize a search strategy. The results that are returned to a user include a hyperlink and a short synopsis of each of the various web content that matches the search strategy. The user can then follow the hyperlink to access the content if it looks promising.

Another aspect of the Internet that has recently received much attention is social networking or social network sites. These sites often allow communities of online users to form and to share content as desired. For example, a user (after creating an account) will typically upload identifying information and content to a virtual space within the social networking site. More particularly, the user can set access permissions for the content so that other users can see or access the content. Other users of the site can then search for friends and other contacts within their social network and visit their content or virtual space. A user can designate other users into social categories such as “friends”, “contacts”, etc. Using these types of labels, virtual communities can form online that have common interests or a common theme.

Both of these areas of the Internet, search engines and social networks, continue to have room for improvement and innovation to make the user experience more useful and more content-rich. In particular, social networking sites continue to need improvement on how content is organized and accessible so that each user can have variable degrees of control when sharing content. Additionally, publishing the content is often difficult because users are limited by the capabilities of third-party e-mail providers or third-party publishing sites (e.g., photo album sharing sites). Also, a common complaint about search engines is that they continue to return too many results in seemingly random order. Thus, there remains an unfilled need for improved search engines and social networking sites on the Internet that improve the efficiency of locating, organizing, and sharing content.

### SUMMARY

One aspect of the present invention relates to a method for ranking search results. In accordance with this method, a respective degree of separation is determined between a searcher and one or more users and one or more groups, wherein both a user and a group may publish individual content to be searched. Then, a plurality of the published individual content that matches a search query is identified and, to create search results, the plurality of the published individual content are ranked according to the respective degree of separation associated with a publisher of the published individual content. Ultimately, the search results are presented to a user.

Another aspect of the present invention relates to a method for limiting a search corpus. In accordance with this method, a respective degree of separation is determined between a searcher and one or more users and one or more groups, wherein both a user and a group may publish individual content to be searched. Then, search results are identified which are a plurality of the published individual content that matches a search query; wherein the identified published individual content includes only content published by users and groups that are within n degrees of separation of the searcher. Ultimately, the search results are presented to a user.

Yet a further aspect of the invention relates to a method that includes the steps of: a) determining a respective degree of separation between a searcher and one or more users and one or more groups, wherein both a user and a group may publish individual content to be searched; b) identifying, as search results, a plurality of the published individual content that matches a search query, wherein the identified published individual content includes only content having a predetermined tag; c) ranking the search results according to the respective degree of separation associated with a publisher of the published individual content; and d) presenting the search results.

It is understood that other embodiments of the present invention will become readily apparent to those skilled in the art from the following detailed description, wherein is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of a computer system are illustrated by way of example, and not by way of limitation, in the accompanying drawings, wherein:

FIG. 1 is a block diagram of a content publishing web site in accordance with the principles of the present invention;

FIG. 2 is a block diagram of individual applications within the web site of FIG. 1;

FIGS. 3-4D depict exemplary interface screen shots of the web site of FIG. 1;

FIGS. 5A-5D depict a series of exemplary interface screen shots of a search tool that considers social networks when returning search results;

FIG. 5E depicts a flowchart of an exemplary method for a search tool that considers social networks when returning search results;

FIGS. 6A-12B depict a series of exemplary interface screen shots of the web site of FIG. 1; and

FIG. 13 depicts a flowchart of an exemplary method of sharing content with internal and external users in accordance with the principles of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

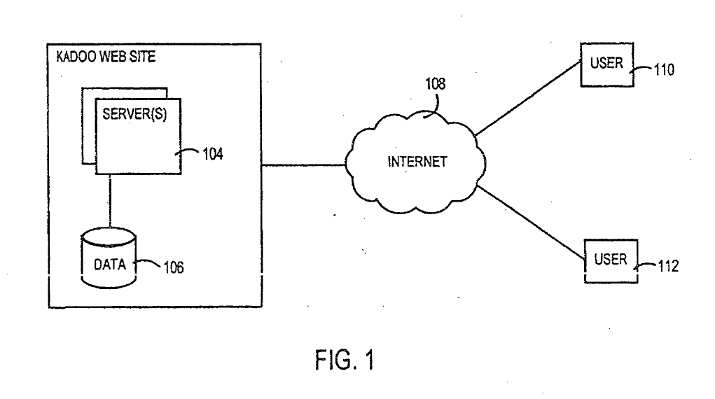

FIG. 1 depicts a functional block view of a networked system for providing socially networked content in accordance with the principles of the present invention. A web site 102 is available through the Internet (or other network) 108 to multiple users 110, 112. The web site 102 is labeled in FIG. 1, and often referred to herein, as “Kadoo”™. This label is not intended to limit the scope of the present invention but is used to identify one exemplary embodiment that is presently available to the community of Internet users. In general, the web site 102 includes one or more servers 104 that communicate with the remote users 110, 112. The servers 104 also have access to data store 106. Thus, content, user information, meta-information about content, and other applications may be served to the users 110, 112 who access the web site 102. In operation, the users 110, 112 create a virtual hard drive on the web site 102 where they can store content and share it with other users. Additional features of the web site 102 are explained in greater detail below.

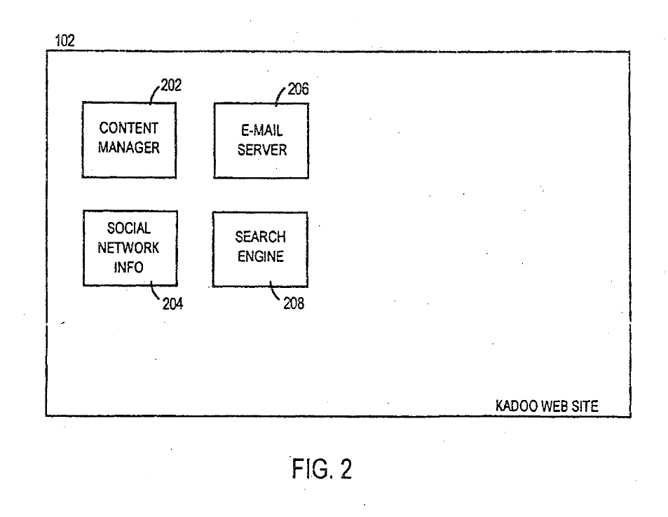

FIG. 2 depicts a block diagram of a subset of the individual software functional blocks or applications that are available through the web site 102. In particular, there is a content manager 202 that is typically responsible for maintaining the content itself, the location information for each user's content, and other meta-data (e.g., tags) about the content. An e-mail server 206 may advantageously be closely coupled with the other components within the web site 102. In this way, the functionality of the e-mail server may be easily made available to the users of the web site 102.

A search engine 208 may be provided that allows a user to perform simple or complex keyword, Boolean, and/or heuristic searching. The web site 102 also includes information 204 about the social network of the users. The social network refers to the groups of other users that are somehow linked or connected to a particular user. For example, a user named Bob may have a set of “friends” and he may belong to a number of “groups”. These other users make up his social network within the context of the web site 102. Within the framework of a social network is also the concept of degrees of separation. Bob is separated from himself by zero degrees of separation. Bob's friends and groups are separated from him by one degree of separation. In other words, an individual user's contacts (e.g., friends, co-workers, family) are considered to be separated from the user by one degree. Each of Bob's friends may also have their own group of identified friends and, thus, they would be “friends of friends” and would be separated from Bob by two degrees of separation. Each group that Bob belongs to also has members and the members of Bob's groups are also considered to be separated from Bob by two degrees of separation. Groups are considered to be more than simply containers of people with a similar interest, they are connectors. The groups a user belongs to are separated from the user by one degree and the groups may publish their own content. However, the members of a group are separated from the user by two degrees. A group may also be affiliated with another group and thus create a connection in that manner. This branching out to further degrees of freedom can continue to occur but it may become unwieldy or unusable after about three degrees of separation. Finally, after an arbitrary determination of how many degrees of separation (e.g., two, three, four) are significant, the rest of the users may be referred to as “everyone”.

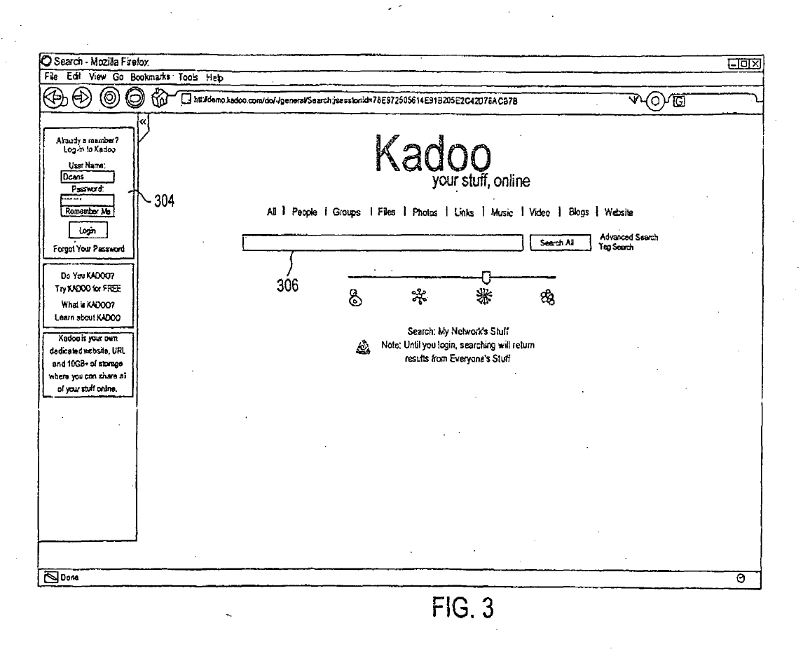

FIG. 3 depicts a welcome screen shot of an exemplary web site that allows users to store content and conduct searching and other content-related functions. The screen shot includes a login area 304 so that only authorized users may access the site. Icons may be provided that indicate the type of content that a user may store and share (or publish). The icons can include, for example, such data as a user profile, an email center, a calendar, a contacts manager, a favorites manager, a blog, a website, a photo album, a file store, a music collection, and a video collection.

The site also includes a search bar 306 that allows a user to enter keywords. One of ordinary skill will readily recognize that the search interface 306 may be more complex without departing from the intended scope of the present invention.

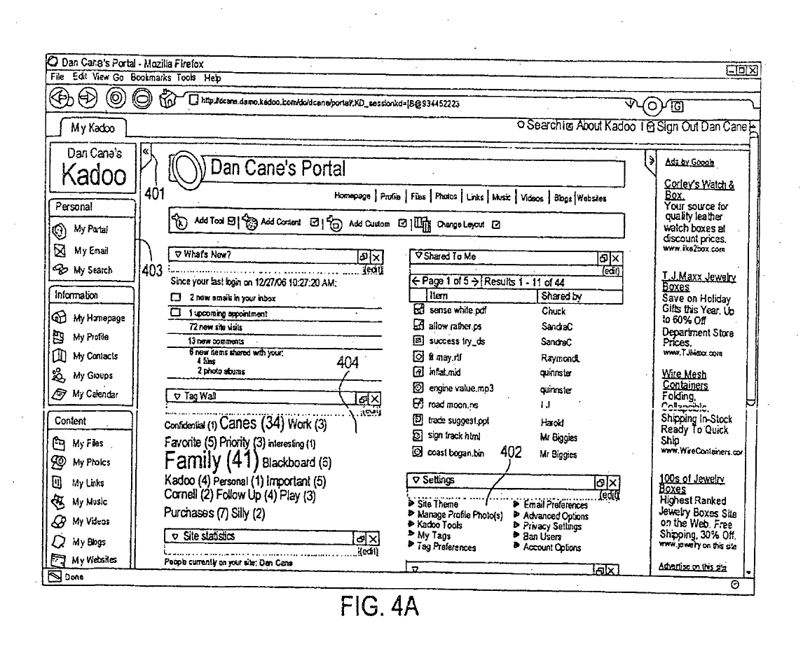

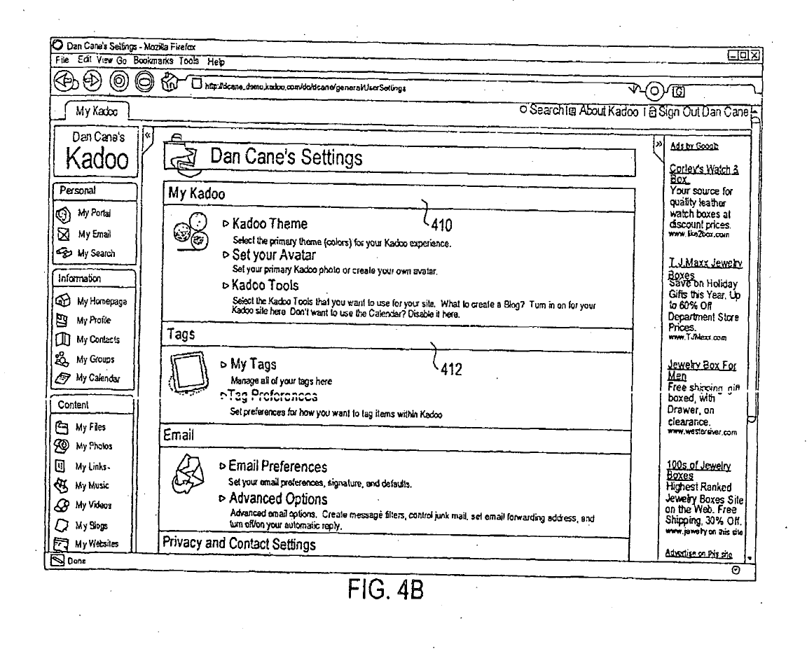

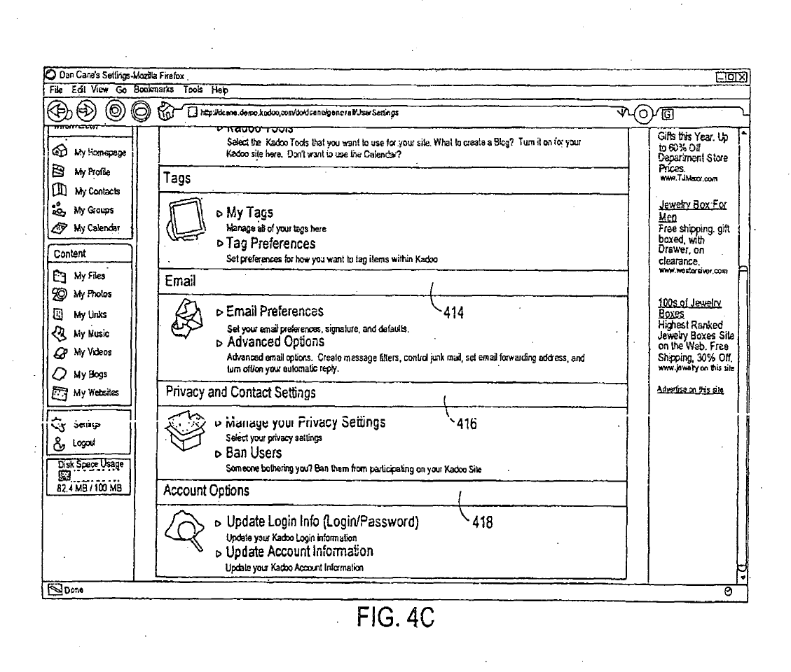

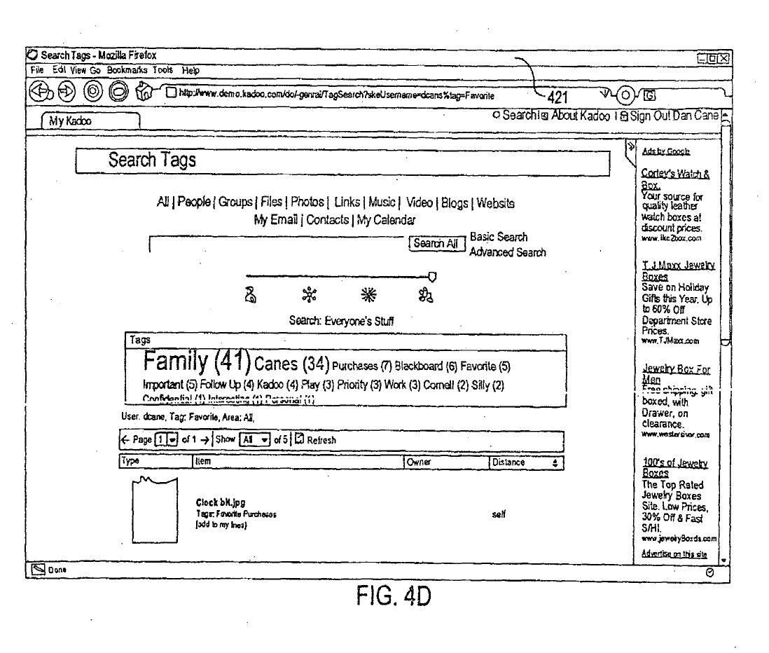

FIG. 4A illustrates an exemplary home page that may be used to initially greet an authorized user once that user logs into the web site. The user has control over the layout of this page and can typically include such areas as a “setting” portion 402 and a “tag” portion 404. Using the links of these portions, the user can, respectively, customize the site's behavior and manage their tags. For example, by selecting the “settings” portion 402, the user can be presented with further options 410 (see FIG. 4B) to customize the appearance of the web site or options 412 to manage their tags. FIG. 4C depicts other “settings” options such as email control 414, privacy settings 416, and account management options 418. From the “tag” portion 404 of FIG. 4A, the user may select one of the tag links (e.g., “Kadoo (4)) and be presented with a screen 421 similar to that of FIG. 4D. Tagging can be used to organize content, links, and evens people within the web site.

A sticky tab 401 is provided that allows the currently displayed page to remain as an active tab. Thus, even if the user moves to other pages or selects other content, the current page remains as a static tab that can be quickly selected. Such a setting may advantageously survive logging on and off the web site so that a user automatically has certain pages tabbed and ready when they log into the system.

A search selection region 403 is also depicted in FIG. 4A that allows a user to search for content related to a desired topic. As mentioned earlier, an exemplary search interface (and underlying search engine) is described for purposes of concreteness but one of ordinary skill would recognize that other search engines and interfaces could be used without departing from the scope of the present invention.

Relationship Weighted Search Results

Today's search engines typically rely on various methods to order (or rank) search results. Some use keyword based methods that consider parameters such as the number of times a keyword appears, its proximity to other words, etc. Other search engines have even developed proprietary algorithms that are more complicated. However, none of the algorithms to date include an understanding of the person conducting the search and how they relate to the “publishers” of the content being searched for.

Within the system of FIGS. 1 and 2, the content from the various users on the web site, or alternatively, the Internet in general, is searchable using any of the existing search algorithms. Additionally, users can tag content with an arbitrary number of labels called “tags” which also become part of the searchable index. It is apparent that a large site with a lot of tagged content can often return too many search results for some users to find helpful. To make the results more usable, or relevant, the search results are ranked based on a relationship between the searcher and the publisher of the content. In particular, the degree of separation between the searcher and the publisher is used to rank the results so that the lower the degree of separation, the higher the ranking. Of course, other more traditional criteria (e.g., date, popularity, etc.) may be used to rank results instead or in combination therewith.

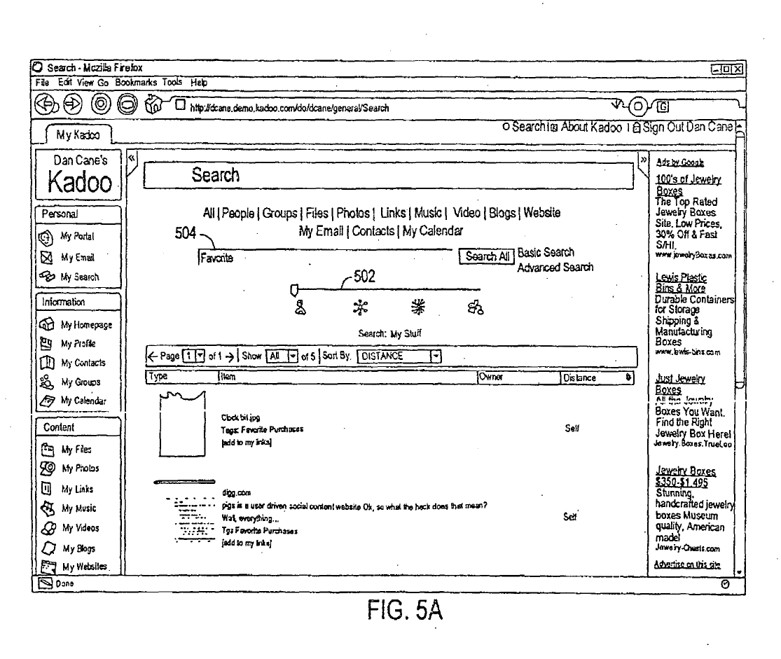

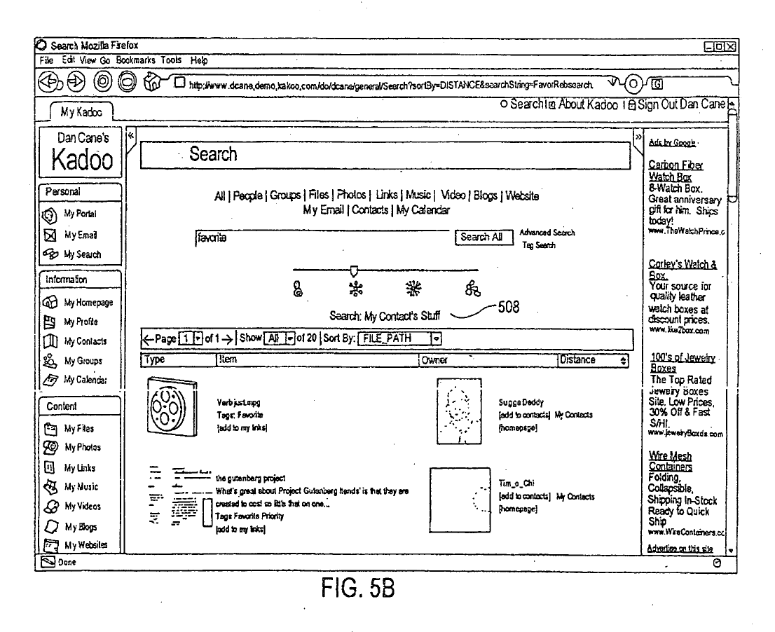

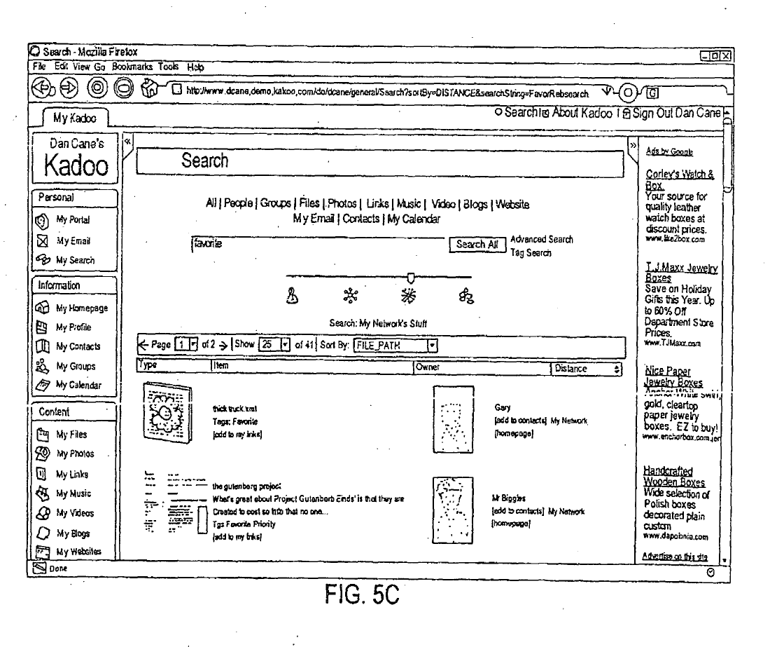

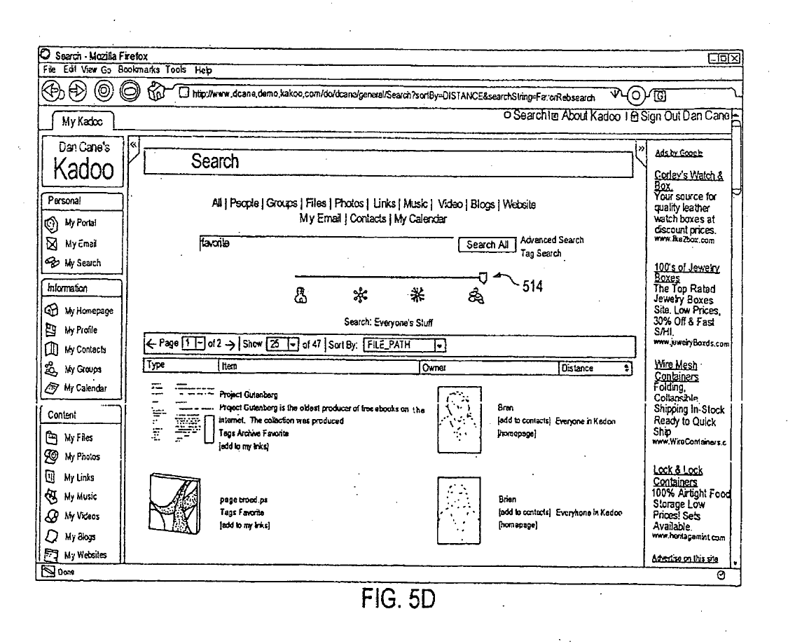

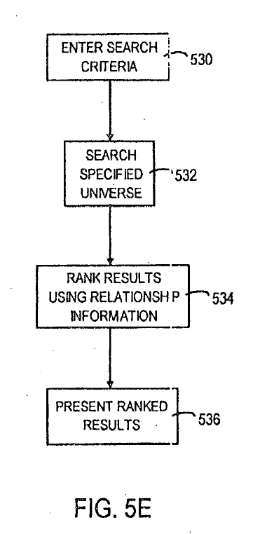

FIGS. 5A-5D depicts a series of exemplary screen shots for a search of content. In FIG. 5A, the search bar 504 is used to enter keywords and the sliding bar 502 controls the size of the universe that is searched for content. For example, in FIG. 5A, the sliding bar is set to indicate that “Everyone” is subject to the search. Thus, the content from all the users of the web site will be searched according to the key words. Any results that are returned will be ranked by the degrees of separation. The identifier 508 of FIG. 5B shows that only content within two degrees of separation will be searched and returned to the user. The indicator 510 of FIG. 5C depicts a setting of the sliding bar that limits search results to only those published by other users separated from the searcher by one degree of separation (or less). In FIG. 5D, the indicator 514 shows a setting where the search corpus and results are limited to the searcher's own content (e.g., zero degrees of separation).

FIGS. 5A-D also show how searches can be limited by content type. In this way, music files, video files, or blogs may be individually searched without cluttering up the results for other types of content. The flowchart of FIG. 5E depicts an exemplary method for implementing the search functionality just described. In step 530, a user enters search criteria for content they desire to locate. As part of this process, the user may also specify, in step 532, the universe or “corpus” over which to conduct the search. The universe may be limited by degrees of separation information or by file type or other similar criteria. In particular, the social network, or relationship, information can be used to create safe searching universes. For example, a child may be limited to searching only within one degree of separation. Thus, by controlling who is a “friend” or “contact” of the child, the universe of possible content that is returned for a search is effectively limited. In general, a boundary is drawn around a network of connected users and groups and searching for content is limited to being within this boundary. The search universe may also be bounded by using tags. For example, a child may be limited to searching only content that is tagged “family” or “Boy Scouts” or some other identifier that limits what possible search results could be returned. Regardless of whether or not the search universe is bounded, in step 534, the search results are returned and then ranked using relationship information between the searcher and the content publisher. Finally, in step 536, the ranked search results are presented to the searcher.

The subset of users that are within n degrees of separation from a user may be determined and then maintained within a database of the web site. Each time a person or group is added to the web site, the model of each user's social network can be recomputed. While this modeling may theoretically occur out to any number of degrees of separation, empirical results show search results are typically unimproved once the degrees of separation is more than two. Thus, one advantageous model of relationships maintained by the web site includes those other users that are within two degrees of separation. Once such a model is computed, then any search results can simply be “JOINed” against the model to identify (and then rank) the search results published by users having a specific degree of separation.

Safety

The web site is advantageously configured to track any users on the site that access (or visit) content for a user, for example, named Bob. When some user accesses a blog or file that belongs to Bob, then a “footprint” is created by the web site that Bob can refer to later to see who was accessing which content and when. Additionally, the detection and tracking features just described may be implemented in near real time so that if Bob is online and some other user accesses Bob's content, then Bob can be alerted. In response, Bob can monitor the situation or even initiate a chat session with the other user. In the other direction, the user may also be provided a tool to allow them to initiate a chat session with the owner of a piece of interesting content.

One related safety concept is that the degrees of separation, or relationship, information may be used to limit viewability of a particular user and that user's content. In operation, Bob can specify that he is not viewable by anyone on the web site that is more than two degrees of separation away. In this manner, strangers will not be able to discover Bob is even a member of the web site or discover any content that Bob may have on the web site.

Email

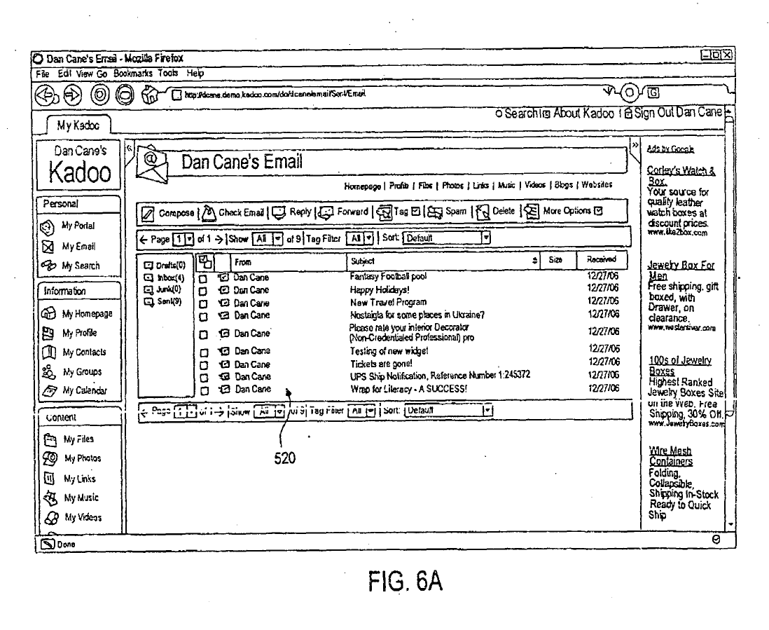

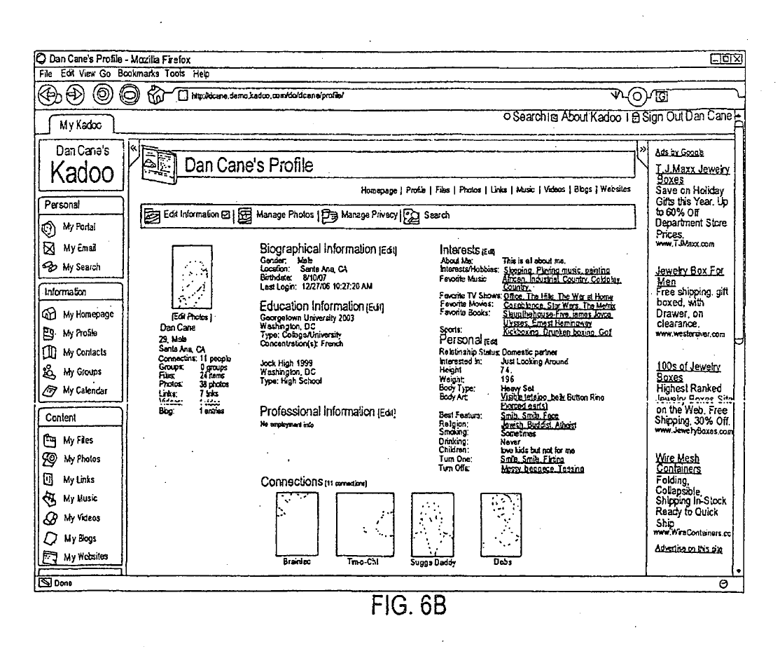

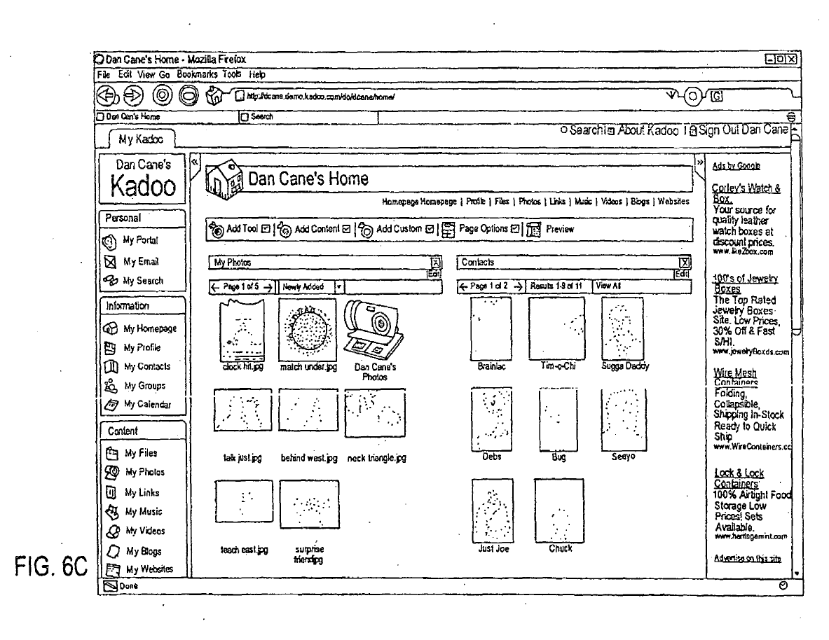

FIG. 6A depicts a screen interface for accessing email functionality of the web site in accordance with the principles of the present invention. In general, the interface screen is typical of e-mail application routinely available to users. As shown in FIG. 2, the email server may be included as part of the web site. This provisioning allows more flexibility with how attachments can be sent to users via email.

When a user creates an e-mail message, that user can be presented with a number of options of how to attach content. For example, a photo album of 10 photos, 3 MB each, may overwhelm some e-mail recipients' capacity or download time. Handling of other types of files or content, not just photos, is contemplated as well even though the specific example below refers to photos. In particular, there are at least five options provided to the user on how to send an attachment:

1. Embed a link (or token) in the e-mail back to the high resolution images.

2. Embed the images as HTML which are thumbnails that result in the images being streamed over the web when the thumbnail is accessed.

3. Attach low-resolution versions of the images into the email that have embed links back to the high resolution images.

4. Attach a compressed file of the high resolution images.

5. Attach the high resolution images.

By having the e-mail server under the control of the web site, all five choices are equally possible. Furthermore, the e-mail server can automatically include links to partners to purchase activities related to handling the content. For example, users may be offered to download a video or pay for copies of photos.

FIGS. 6B illustrates an exemplary profile page that may be used by other members of the web site to learn more about the user. Thus, some or all of this information may be public or private depending on the settings of the user. Additionally, updates to this information can occur through some type of management application. In addition to the profile page, a user may set up there own homepage that other users can visit, such as the one in FIG. 6C. The present system can advantageously include a WYSIWYG editor to simplify web page creation.

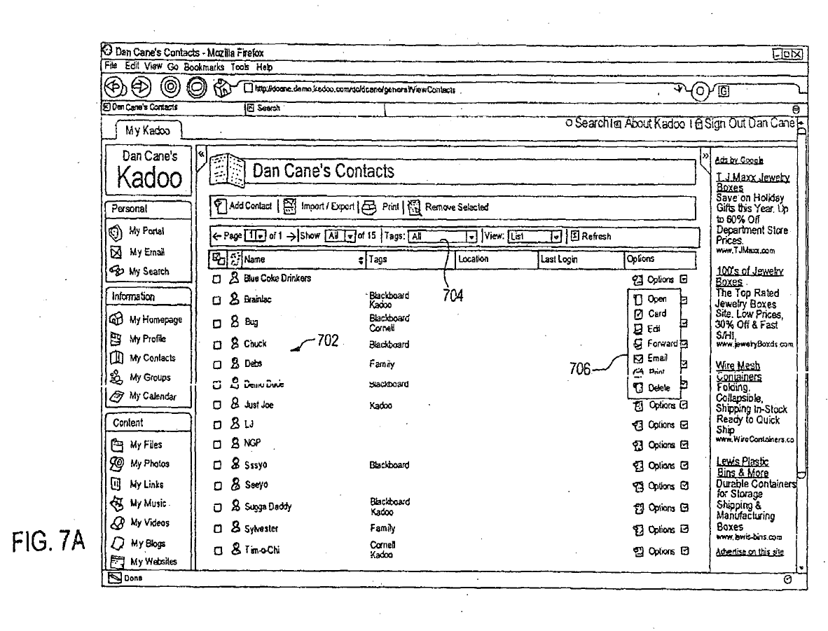

FIG. 7A depicts a contact manager interface screen through which a user can manipulate contact-related information 702. The selection box 704 is set to show “All” tags so the interface screen shows all the contacts for this user. However, the user could have selected another setting (e.g., “Family”) and only contacts having that matching tag would have been displayed. The contacts in the list are not necessarily limited to only other members of the web site. Instead, a contact may be anyone with whom the user has a relationship. The option selection box 706 depicts some of the options that can be used in conjunction with a contact.

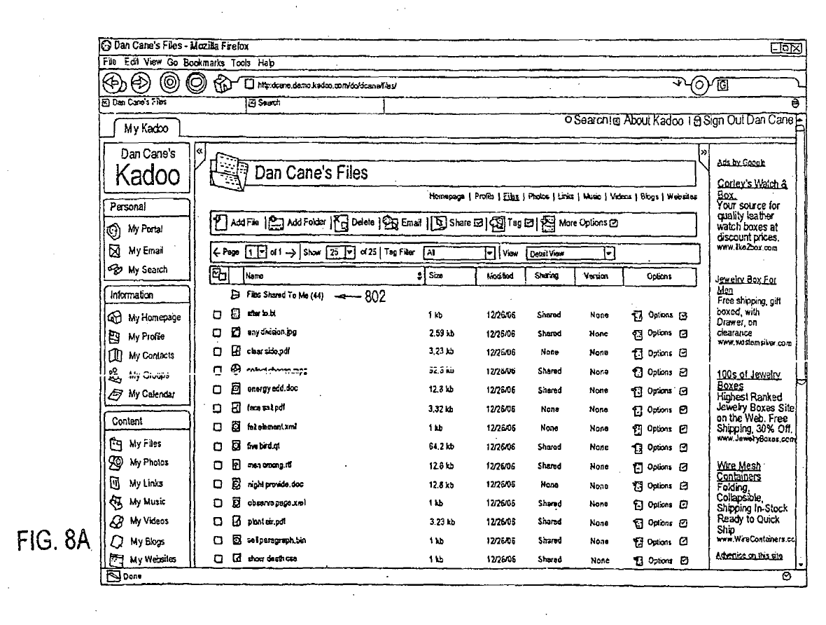

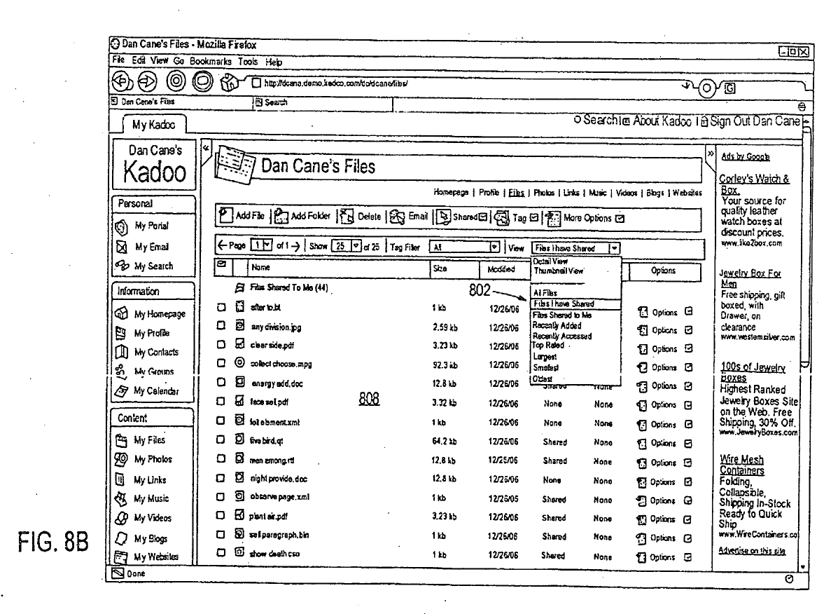

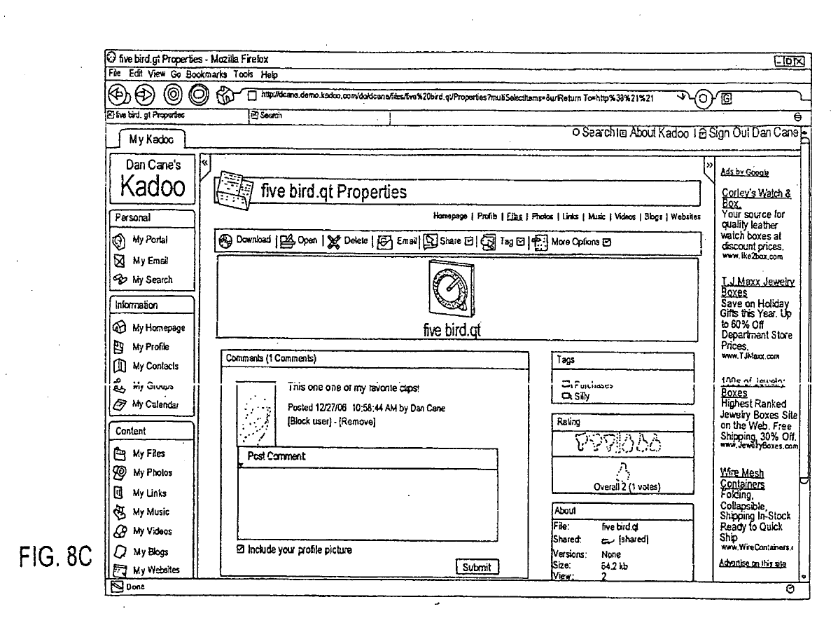

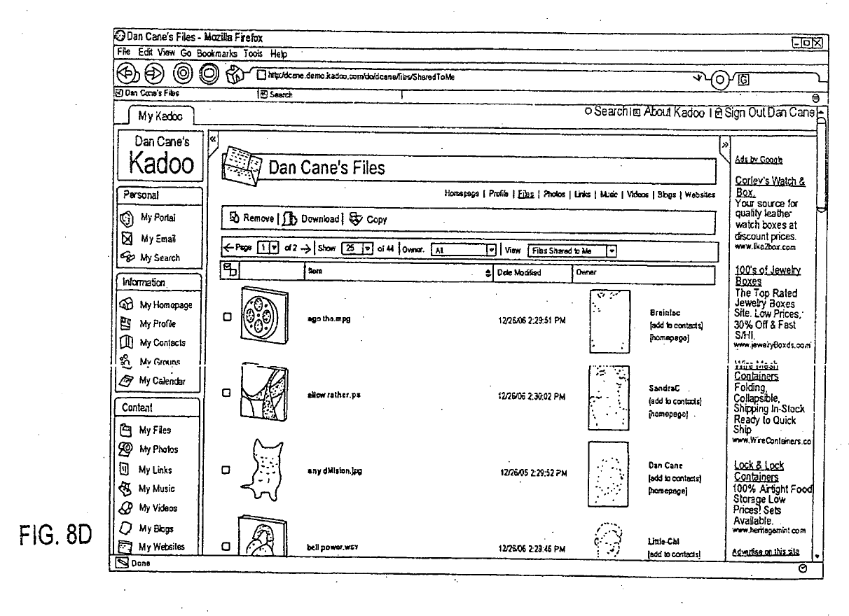

FIG. 8A depicts an interface screen that summarizes the files available to the user, including files that are shared to that user 802. FIG. 8B depicts an interface screen shot showing the availability of: All Files; Files I have Shared; Files Shared to Me; Recently Added; Recently Accessed; Top Rated; Largest; Smallest; and Oldest. By clicking on item 802, a screen (see FIG. 8C) can be displayed that provides detailed information about the files themselves, as well as tags and ratings. FIG. 8D is an interface screen that shows who has shared a file to the user.

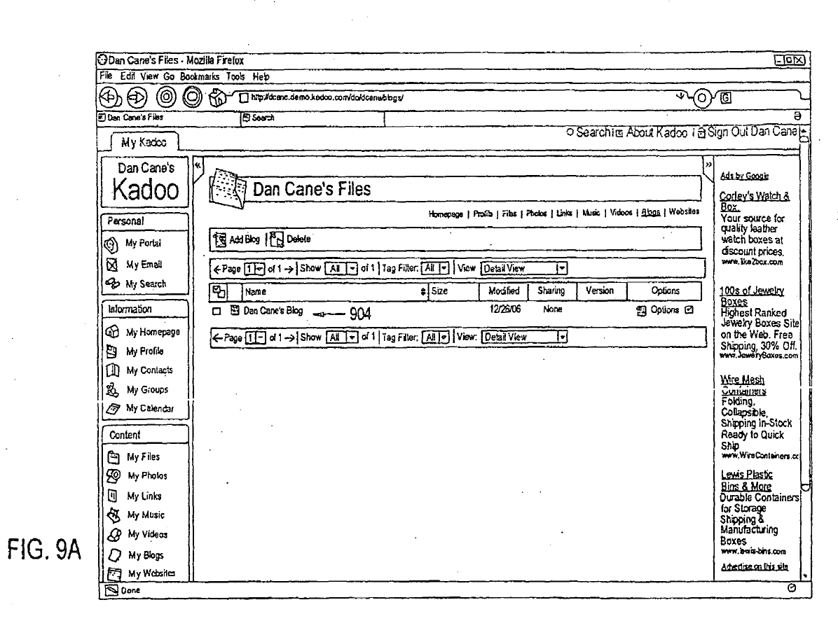

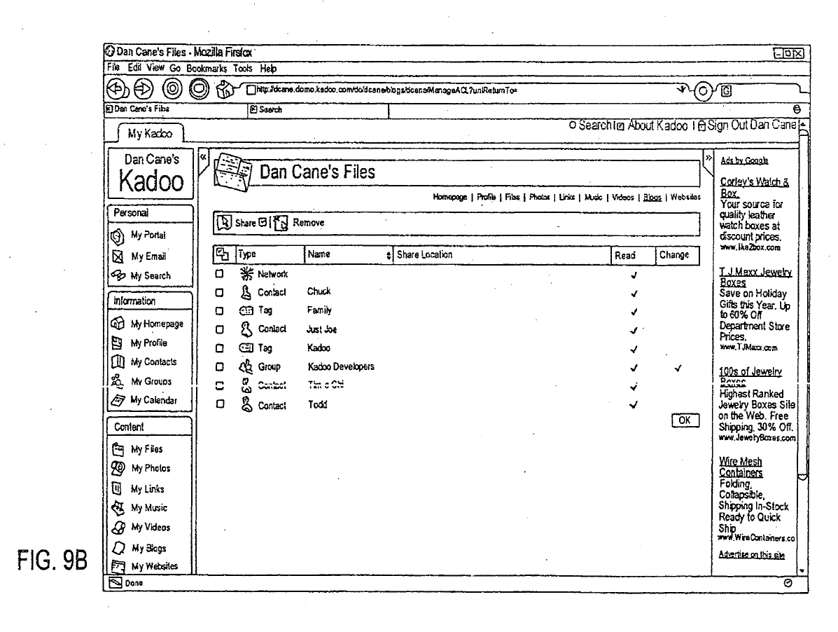

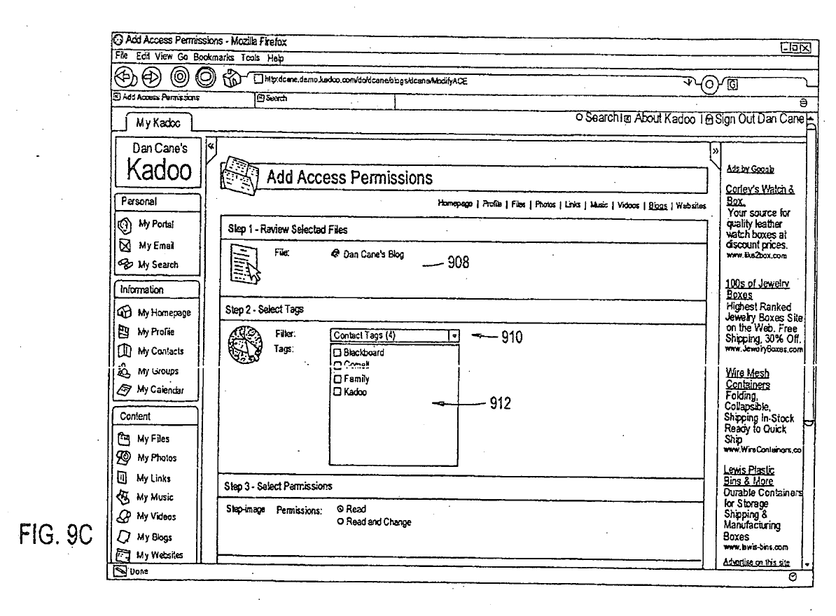

As mentioned earlier, a blog is one example of content that may be published by a user. FIGS. 9A-9C show an exemplary process for creating a blog. Information about the blog can be displayed by selecting the link 904 to the blog (see FIG. 9B). Selecting the “Add” button 902 from the screen in FIG. 9A will result in the display of the screen of FIG. 9C. The name 908 of the new blog is displayed along with settings for how it is to be managed. For example, the blog may be tagged in “Step 2” by selecting the type of tag 910 and the name of the tag 912. Of course a new tag could be created during this process. Another important setting for the blog is the access permission 914 that are granted to users to whom this content is shared. The blog of FIGS. 9A-9C was selected as an example of the type of content a user may publish. In addition to blogs, a user may publish files, videos, music, photos, etc. Similar functionality described with respect to creating a new blog is also present for these other types of content as well.

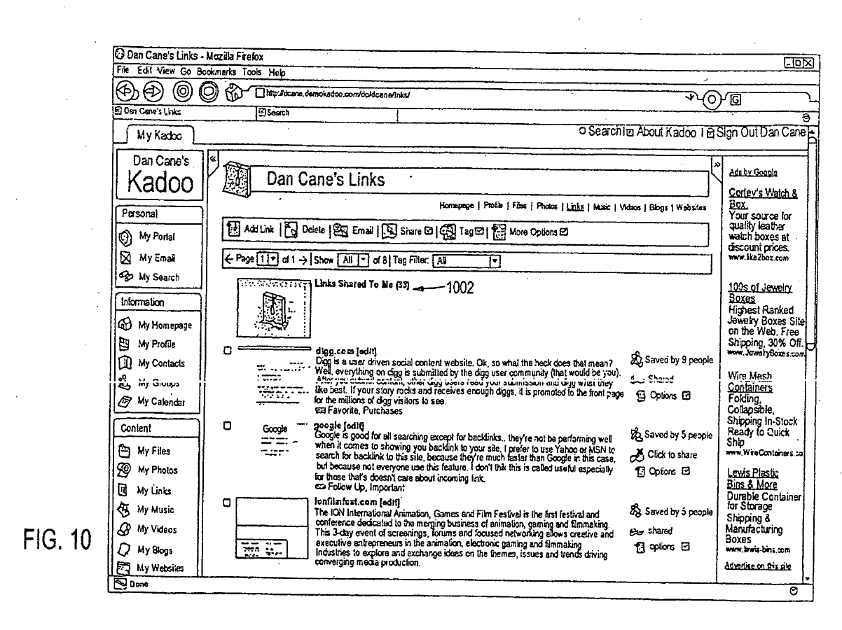

FIG. 10 depicts an interface screen that shows links 1002 that are shared to the user. By selecting link 1002, more information about each link can be displayed by the user. For example, the name of the link, the owner of the link, and the time it was shared may be displayed. From this display, a user may select one of the other users and be displayed the public information from that user's profile.

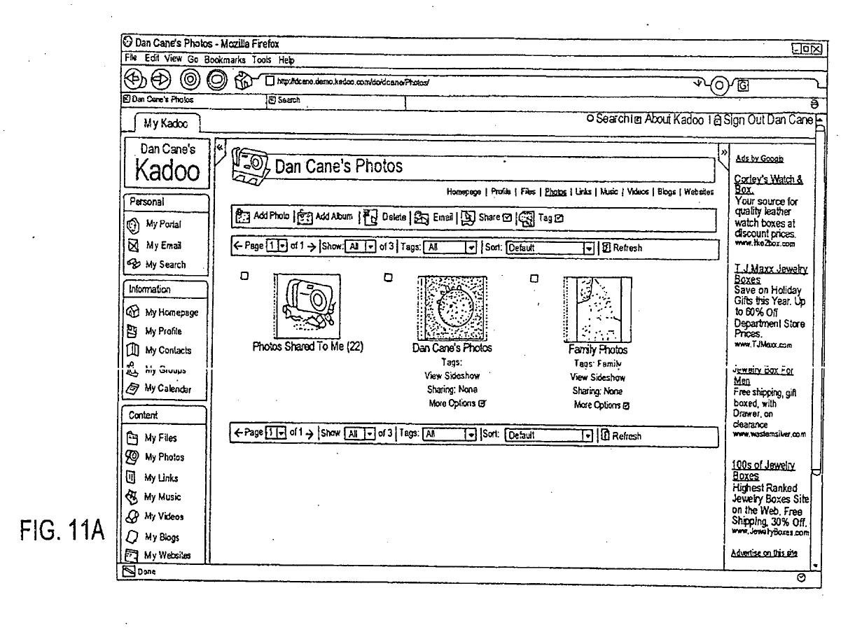

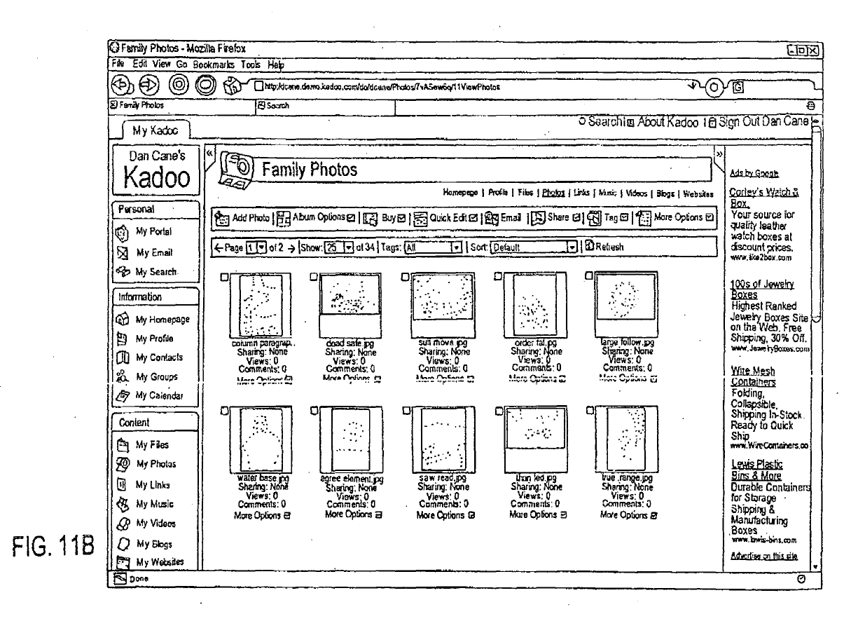

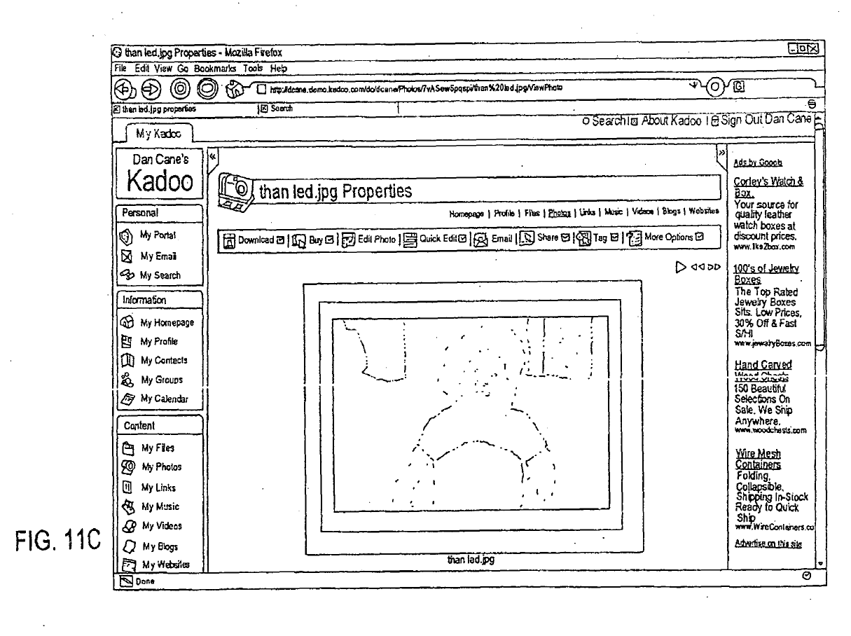

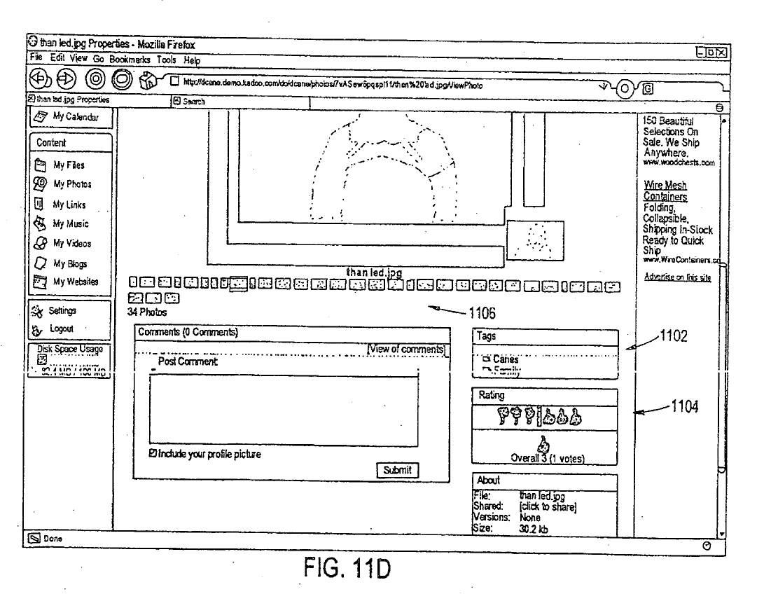

FIG. 11A is a screen shot depicting albums available to the user, while FIG. 11B depicts photographs available within the album. FIG. 11C depicts a specific photograph within the album. FIG. 11D depicts tags 1102 and ratings 1104 for a specific photograph, and thumbnails 1106 for other photographs in the album.

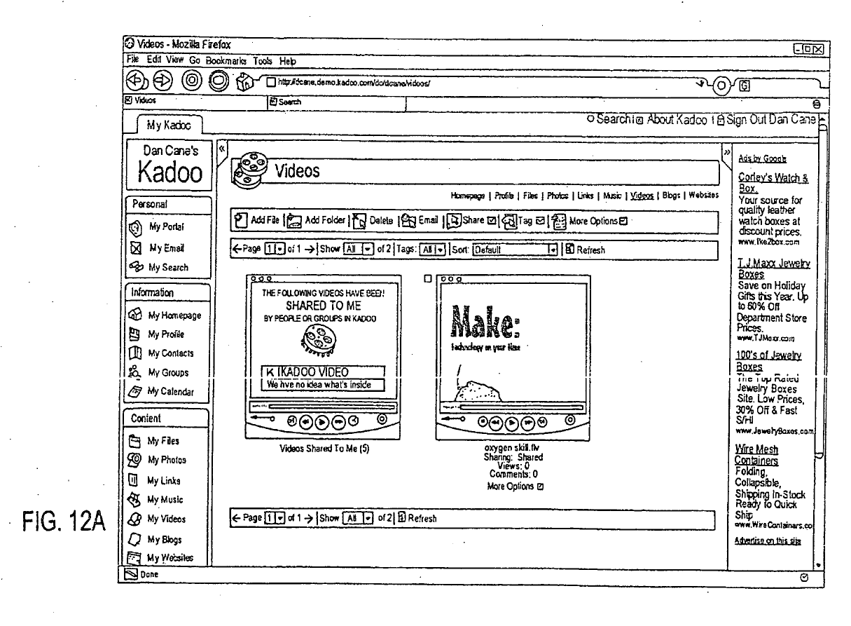

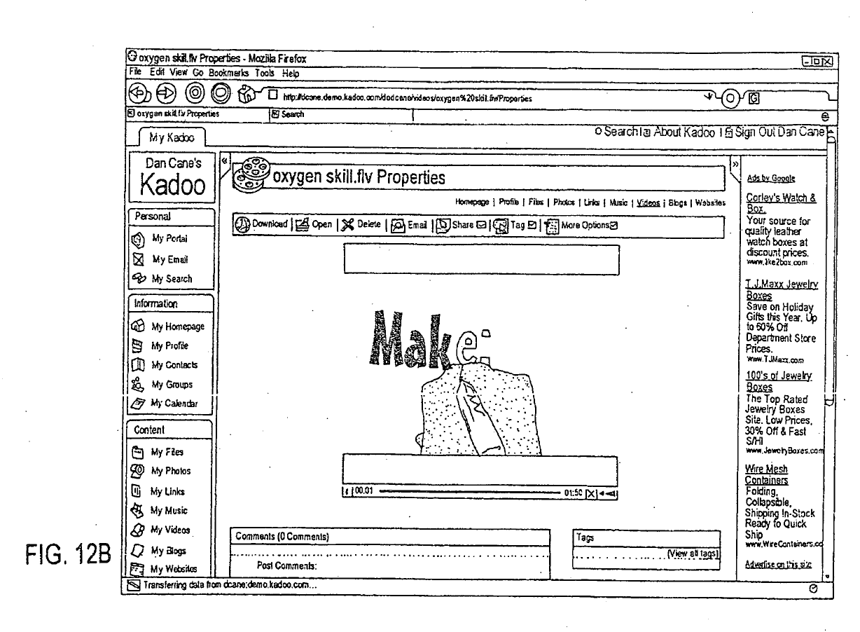

FIG. 12A shows a listing of available videos and FIG. 12B depicts the playing of a video within the web site 102.

Sharing to External Users

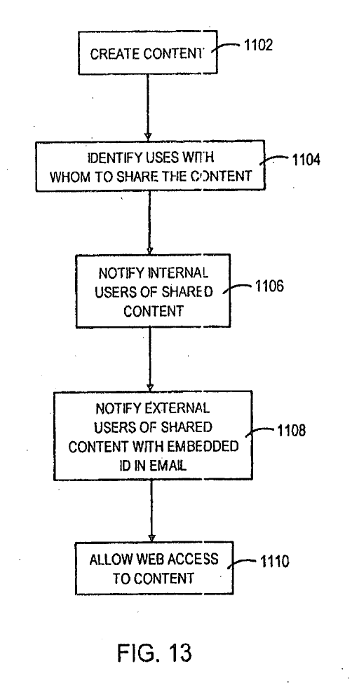

Because contacts for a user may not necessarily be another member of the web site, the user may select to share information outside of the web site. However, this has typically been accomplished in the past by requiring the information be marked “public” which could often have unwanted consequences. However, the present web site allows a content item to be shared outside the web site without making it public; an exemplary method is depicted in the flowchart of FIG. 13. After a user creates content, in step 1102, they can also specify who that content may specifically be shared with, in step 1104. Often times, the easiest way to identify those parties is to present the user with a copy of their contacts book and have them select. If a desired recipient is not listed, then the user can add the new contact on-the-fly. Part of specifying a user with whom to share the content is specifying the access rights (e.g., read, edit, etc.) that the user has with respect to the content. Thus, internal and external users may be identified, each have appropriate permissions, with respect to shared content.

Internal users of the web site are easier to handle because the web site has functionality in place to recognize a user and the permissions they may have with respect to content. However, allowing access to an external user does not occur in the same manner. In step 1106, internal users are notified as always of content being newly shared to them. In step 1108, however, the external users are notified via an e-mail that includes a link to the shared content. That link includes an embedded ID that the web site uses to control access to the content. In operation, the web site may create a unique ID for every external user that is added to a contact list. This unique ID can be embedded in the e-mailed link so that when the link is used to try to access the content, the web site can verify that the unique ID has the appropriate permission.

Sharing by Tags

Instead of specifying a “contacts” list of people with whom to share a content item as just described, the present web site also allows sharing based on tags. In particular, from a user's contact list, there may be a group of people tagged “Family” and another group tagged “Co-Workers”. By specifying that content should be shared based on these tags, photos can be easily shared to family without also distributing them to co-workers. This type of sharing allows for dynamic sharing such that if a new contact is added with the “Family” tag, then they automatically get notice of all the previous content shared to the family.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The various illustrative logical blocks, modules, circuits, elements, and/or components described in connection with the embodiments disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for ranking search results comprising the steps of:
determining a respective degree of separation between a searcher and one or more users and one or more groups, wherein both a user and a group may publish individual content to be searched;
identifying a plurality of the published individual content that matches a search query;
ranking, to create search results, the plurality of the published individual content according to the respective degree of separation associated with a publisher of the published individual content; and
presenting the search results.

2. The method of claim 1, further comprising presenting the search results to the searcher.

3. The method of claim 1, further comprising the step of:
modeling the respective degree of separation between a searcher and at least one of one or more users and one or more groups.

4. The method of claim 3, wherein the step of modeling is performed before the step of identifying.

5. The method of claim 3, wherein the step of modeling includes modeling only users and groups that are within n degrees of separation of the searcher.

6. The method of claim 5, wherein n equal 2.

7. The method of claim 3, wherein when the group is one degree of separation from the searcher and a user is a member of that group and is not independently one degree of separation from the searcher, then the user is considered two degrees of separation from the searcher.

8. The method of claim 3, wherein each affiliation of a group or membership in a group is a degree of separation.

9. The method of claim 1, further comprising:
including in the search results only content published by users and groups that are within n degrees of separation of the searcher.

10. A method for limiting a search corpus comprising the steps of:
determining a respective degree of separation between a searcher and one or more users and one or more groups, wherein both a user and a group may publish individual content to be searched;
identifying, as search results, a plurality of the published individual content that matches a search query; wherein the identified published individual content includes only content published by users and groups that are within n degrees of separation of the searcher; and
presenting the search results.

11. The method of claim 10, further comprising the step of:
ranking the search results according to the respective degree of separation associated with a publisher of the published individual content.

12. A method for limiting a search corpus comprising the steps of:
determining a respective degree of separation between a searcher and one or more users and one or more groups, wherein both a user and a group may publish individual content to be searched;
identifying, as search results, a plurality of the published individual content that matches a search query; wherein the identified published individual content includes only content having a predetermined tag;
ranking the search results according to the respective degree of separation associated with a publisher of the published individual content; and
presenting the search results.

13. Computer readable medium bearing instructions for ranking search results that upon execution cause one or more processors to perform the steps of:
determining a respective degree of separation between a searcher and one or more users and one or more groups, wherein both a user and a group may publish individual content to be searched;
identifying a plurality of the published individual content that matches a search query;
ranking, to create search results, the plurality of the published individual content according to the respective degree of separation associated with a publisher of the published individual content; and
presenting the search results.

14. Computer readable medium bearing instructions for limiting a search corpus that upon execution cause one or more processors to perform the steps of:
determining a respective degree of separation between a searcher and one or more users and one or more groups, wherein both a user and a group may publish individual content to be searched;
identifying, as search results, a plurality of the published individual content that matches a search query; wherein the identified published individual content includes only content published by users and groups that are within n degrees of separation of the searcher; and
presenting the search results.

15. Computer readable medium bearing instructions for limiting a search corpus that upon execution cause one or more processors to perform the steps of:
determining a respective degree of separation between a searcher and one or more users and one or more groups, wherein both a user and a group may publish individual content to be searched;
identifying, as search results, a plurality of the published individual content that matches a search query; wherein the identified published individual content includes only content having a predetermined tag;
ranking the search results according to the respective degree of separation associated with a publisher of the published individual content; and
presenting the search results.

16. A system for ranking search results comprising:
a relationship modeler configured to determine a respective degree of separation between a searcher and one or more users and one or more groups, wherein both a user and a group may publish individual content to be searched;
a search engine configured to identify a plurality of the published individual content that matches a search query;
a ranking apparatus in communication with the relationship modeler and the search engine, configured to create search results, by ranking the plurality of the published individual content according to the respective degree of separation associated with a publisher of the published individual content; and
an interface configured to present the search results.

17. The system of claim 16, wherein the relationship modeler is configured to model only users and groups that are within n degrees of separation of the searcher.

18. The system of claim 17, wherein n equal 2.

19. The system of claim 16, wherein the search engine includes a filter configured to include in the search results only content published by users and groups that are within n degrees of separation of the searcher.

20. A system for limiting a search corpus comprising:
a relationship modeler configured to determine a respective degree of separation between a searcher and one or more users and one or more groups, wherein both a user and a group may publish individual content to be searched;
a search engine configured to identify, as search results, a plurality of the published individual content that matches a search query; wherein the identified published individual content includes only content published by users and groups that are within n degrees of separation of the searcher; and
a user interface configured to present the search results.

21. A content publishing system comprising:
a data repository configured to store respective content for each of a plurality of users;
an email server in communication with the data repository and configured to:
receive a message from one of the users to forward to a plurality of remote locations;
attach information to the message about a particular content published by the one of the users; and
forward the message and the attached information to the plurality of remote locations.

22. A method for sharing content from a content publishing system, comprising the steps of:
receiving from a user of the content publishing system an identity of a plurality of recipients with whom to share particular content, a first portion of the plurality of recipients being internal users of the content publishing system and a second portion of the plurality of recipients being users external to the content publishing system;
generating a respective unique code associated each of the second portion of the plurality of users;
sending a respective message to each of the second portion of the plurality of users that includes the associated unique code; and
determining whether to allow a request to access the particular content based on whether the request includes one of the associated unique codes.
